(19) United States
(12) Patent Application Publication
(10) Pub. No.: US 2010/0181517 A1
(43) Pub. Date: Jul. 22, 2010

(54) Helical Fluid Flow Conduit

(76) Inventor: Fernando Roberto Paz Briz, Sinaloa (MX)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 12/354,964

(22) Filed: Jan. 16, 2009

(51) Int. Cl. F16K 15/00; F15D 1/00

(52) U.S. Cl. 251/324; 138/37

(57) ABSTRACT

A conduit with helical fluid flow. The conduit has a generally cylindrical housing with a side wall coupled with opposing end walls. An inlet and an outlet are coupled with the side wall. At least a portion of the inlet, and preferably the outlet, is tangential to the side wall to promote helical fluid flow within the conduit. Alternatively, the conduit includes a piston positioned within the housing that is moveable between an open position allowing fluid to flow from the inlet to the outlet and a closed position blocking fluid flow from the inlet to the outlet.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

This invention relates generally to conduits, and more particularly to a conduit with helical fluid flow for improving the flow of any fluid, including a suspension of solids within a fluid.

2. Description of Related Art

There are many different types of conduits used to distribute flow within a hydraulic or pneumatic system. For example, an elbow diverts fluid at a specified angle, such as 45 or 90 degrees, from the direction that the fluid enters the elbow. A “tee” fitting typically consists of one inlet and two outlets, one of which is aligned with the inlet and the other of which is positioned at an angle with respect to the inlet. There is a substantial loss of pressure in all of these conventional flow distribution conduits because they require that the entering fluid suddenly change direction.

Some of the different types of valves used to regulate fluid flow include a ball valve, a butterfly valve, a gate valve, a globe valve, and a check valve. A ball valve consists of a ball positioned within a fluid flowing conduit. The ball has an interior passageway. To open the valve, the ball is rotated until its interior passageway is aligned with the conduit. A butterfly valve has a flat disk positioned within a conduit. To open the valve, the disk is rotated within the conduit such that the edge of the disk faces the flowing fluid. A gate valve includes a gate which is positioned within the path of fluid. To open the valve, the gate is typically moved in a direction perpendicular to the direction of fluid flow through the valve. A globe valve typically has a seat with a circular opening positioned within a conduit. Fluid flowing through the conduit must flow upward through the opening in the globe valve. To close the valve, a plug is lowered into the seat, thus blocking the fluid from flowing through the opening.

A check valve is a valve that only allows fluid flow in one direction. A typical check valve consists of a plug that seals an opening in a seat and a spring which biases the plug into contact with the seat. The valve opens when fluid pressure on the valve side opposite the spring reaches a high enough level to compress the spring. Fluid cannot flow through the valve in the opposite direction, however, because the plug engages the seat and blocks fluid from flowing through the valve.

None of the above-described valves is well-suited for regulating the flow of a liquid-solid suspension because each has an internal valve mechanism that is susceptible to damage from repeated impacts with the solids within the liquid-solid suspension. Many of the valves described above also cause a relatively large pressure loss when installed within a hydraulic or pneumatic system.

### BRIEF SUMMARY OF THE INVENTION

A conduit according to a preferred embodiment of the present invention comprises a generally cylindrical housing having a side wall coupled with opposing end walls. An inlet and an outlet are coupled with the side wall. At least a portion of the inlet is tangential to the side wall such that the path of fluid flow between the inlet and the outlet is generally helical. The conduit according to the present invention causes less pressure loss than a conventional flow distribution conduit because the fluid does not suddenly change direction when flowing from the inlet to the outlet. Rather, in the conduit according to the present invention, the fluid follows a generally helical path from the inlet to the outlet.

According to another embodiment of the present invention a piston is positioned within the housing and is moveable between an open position allowing fluid to flow from the inlet to the outlet and a closed position blocking fluid flow from the inlet to the outlet. Thus, the conduit is a valve for regulating fluid flow between the inlet and the outlet. The valve according to the present invention is well suited for regulating the flow of a liquid-solid suspension because there are no internal valve mechanisms which are susceptible to damage from repeated impacts with the solids within the liquid-solid suspension. Further, the valve according to the present invention does not cause a large pressure loss when installed within a hydraulic or pneumatic system.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of a valve according to one embodiment of the present invention;

FIG. 2 is a front elevational view, with portions broken away, of the valve of FIG. 1 showing a piston in an open position;

FIG. 3 is a front elevational view, with portions broken away, of the valve of FIG. 1 showing the piston in an intermediate position;

FIG. 4 is a front elevational view, with portions broken away, of the valve of FIG. 1 showing the piston in a closed position;

FIG. 5 is a front elevational view, with portions broken away, of an alternative embodiment of a valve according to the present invention showing the piston spring-biased to a closed position;

FIG. 6 is a front elevational view, with portions broken away, of the valve of FIG. 5 showing the piston in an open position;

FIG. 7 is a front elevational view of a conduit according to the present invention having one inlet and one outlet; and

FIG. 8 is a side cross-sectional view of one section of the valve of FIG. 1.

### DETAILED DESCRIPTION OF PREFERRED EMBODIMENT

Referring now to FIG. 1, a valve according to one embodiment of the present invention is indicated generally as 10. The valve has a cylindrical housing 12 comprising three joined sections 14, 16, and 18, and a pair of end walls 20 and 22 joined with sections 14 and 18, respectively. The housing 12 has a generally enclosed cylindrical space with an interior surface 24, as shown in FIG. 8. An inlet 26 is rigidly joined with inlet section 14 and is in fluid communication with the interior of housing 12. Likewise, a first outlet 30 and a second outlet 32 are rigidly joined with first outlet section 16 and second outlet section 18, respectively, and each outlet is in fluid communication with the interior of housing 12. As best shown in FIG. 8, a portion of inlet 26 is tangential to interior surface 24 such that fluid entering inlet 26 follows a generally helical path through housing 12. Preferably, a portion of each of first and second outlets 30 and 32 is also tangential to interior surface 24. Although the valve is shown with one inlet and two outlets, it is within the scope of the invention for the valve to have any number of inlets and outlets.

Referring now to FIG. 2, end wall 22 has a central opening 33 for receiving a shaft 34 extending through the center of the housing's interior. End wall 20 also has a central opening (not shown) for receiving shaft 34. A piston 36 is rigidly joined with shaft 34 and is positioned within the housing for regulating fluid flow between inlet 26 and outlets 30 and 32. Although valve 10 is shown with a piston joined to a shaft, in an alternative embodiment of the invention the valve is a flow distribution conduit without a piston or shaft.

Referring now to FIG. 2, inlet section 14 has a side wall 37 and two flanges 38a and 38b positioned at opposite ends of the inlet section. Likewise, first outlet section 16 has a side wall 39 and two flanges 40a and 40b and second outlet section 18 has a side wall 41 and two flanges 42a and 42b. The interior surfaces of side walls 37, 39 and 41 form interior surface 24, shown in FIG. 8. Each flange has an equal number of openings spaced around the outer perimeter of the flange for receiving fasteners to join the sections 14, 16 and 18 and create a continuous cylindrical interior surface 24 (shown in FIG. 8). End walls 20 and 22 also have an equal number of openings as the flanges on sections 14, 16 and 18. The aligned openings in end wall 20 and flange 38a receive fasteners, one of which is shown as 44 in FIG. 2, and the aligned openings in end wall 22 and flange 42b receive fasteners to enclose the interior of the housing. Likewise, the aligned openings in flanges 38b and 40a receive fasteners to join sections 14 and 16, and the aligned openings in flanges 40b and 42a receive fasteners to join sections 16 and 18. Although sections 14, 16 and 18 and end walls 20 and 22 are shown as being joined with fasteners, it is within the scope of the invention for any of the end walls and housing sections to be integral or joined by any means known in the art such as welding. The end walls and housing sections may also be joined using quick release clamps so that the inlet and outlets can be positioned at any angle relative each other.

Inlet 26 is joined with side wall 37 adjacent end wall 20, second outlet 32 is joined with side wall 41 adjacent end wall 22, and first outlet 30 is joined with side wall 39 between inlet 26 and second outlet 32. Inlet 26 is preferably joined with side wall 37 by welding, however, it is within the scope of the invention for inlet 26 to be joined with side wall 37 by any other means known in the art. Likewise, first and second outlets 30 and 32 are preferably joined with side walls 39 and 41, respectively, by welding. Inlet 26 extends from the housing in a first direction and first outlet 30 extends from the housing in a second direction which is positioned at an approximately 45 degree angle from the first direction, however, it is within the scope of the invention for the angle between the first and second directions to be any value. In one embodiment, the angle between the first and second directions is between 90 to 270 degrees. The angle between the first and second directions is easily adjustable by removing the fasteners joining flanges 38b and 40a, rotating section 16 relative to section 14 until different openings in flanges 38b and 40a align, and then inserting the fasteners in the aligned openings. Second outlet 32 extends from the housing in a third direction which is at an approximately 135 degree angle from the first direction, however, the third direction may be positioned at any angle with respect to the first direction. The angle between the first and third directions may also be adjusted in the same manner described above with respect to adjusting the angle between the first and second directions. It should be appreciated that the angles between the first and second directions and first and third directions may be adjusted to any value if quick release clamps are used to join the housing sections. The ratio between the diameter of housing 12 to the diameter of inlet 26 is preferably between 1 to 5, however, it is within the scope of the invention for the ratio between the housing and inlet diameters to be any value.

Referring now to FIGS. 2 and 8, piston 36 is a generally flat, circular plate with an outer peripheral surface adjacent interior surface 24 of housing 12. A seal 46 encircles piston 36 and engages the interior surface 24 of housing 12 for preventing fluid from leaking beyond the piston. Preferably, piston 36 has a groove, positioned in the center of its outer peripheral surface, which retains seal 46. Piston 36 is preferably joined with shaft 34 by welding, however, it is within the scope of the invention for the piston and shaft to be coupled with a key and set-screw or joined by any other method known in the art. Each of the components of valve 10 are preferably constructed from a metal such as steel, stainless steel, iron or aluminum, however, it is within the scope of the invention for the valve components to be constructed from any material such as polyvinylchloride or another synthetic polymeric material.

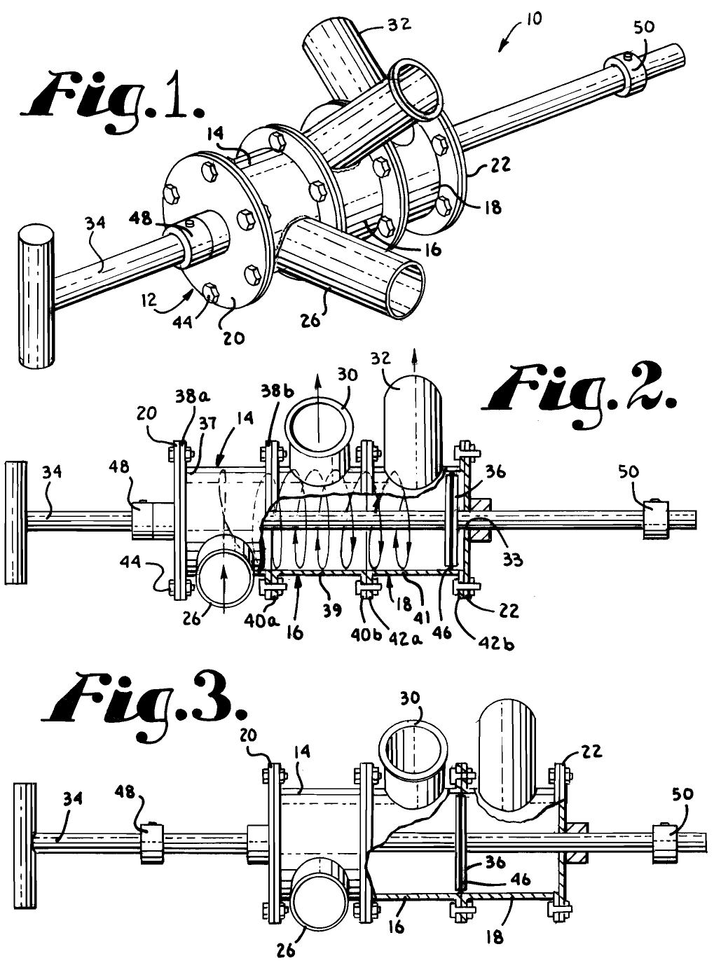

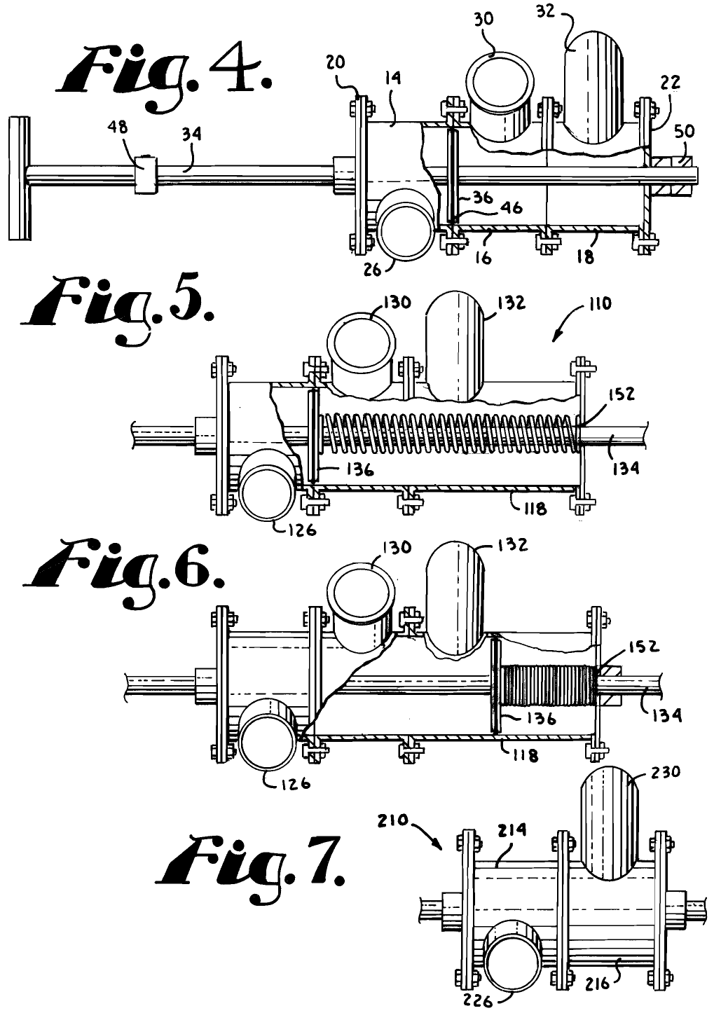

Piston 36 moves between the open position shown in FIG. 2, the intermediate position shown in FIG. 3, and the closed position shown in FIG. 4 for regulating fluid flow between the inlet 26 and outlets 30 and 32. The piston moves in a direction that is generally perpendicular to the first, second and third directions described above. When piston 36 is in the open position, shown in FIG. 2, fluid may flow from inlet 26 to either of outlets 30 or 32. When piston 36 is in the intermediate position, shown in FIG. 3, fluid may flow from inlet 26 through outlet 30, but fluid may not flow through outlet 32. Finally, when piston 36 is in the closed position, shown in FIG. 4, fluid may not flow between inlet 26 and either of outlets 30 or 32. A shaft collar 48 abuts end wall 20 when piston 36 is in the open position shown in FIG. 2 to provide an indication that the piston is in the open position. Another shaft collar 50 abuts end wall 22 when piston 36 is in the closed position shown in FIG. 4. Shaft collar 50 prevents piston 36 from moving beyond the closed position, which would allow fluid to flow between inlet 26 and outlets 30 and 32. Shaft 34 and piston 36 may be moved by any means known in the art, including manually or a mechanical, electromechanical, pneumatic, or hydraulic system that is controlled either manually or via a computer.

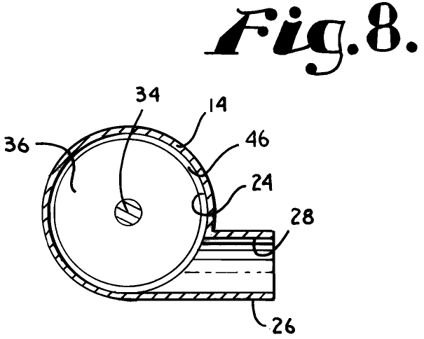

Referring now to FIG. 5, an alternative embodiment of valve according to the present invention is shown generally as 110. Valve 110 is substantially similar to valve 10, shown in FIGS. 1-4 and 8, except valve 110 has a coil compression spring 152 with a central opening received by shaft 134, and a second outlet section 118 that is slightly longer than the second outlet section of valve 10. Spring 152 biases piston 136 to the closed position, as shown in FIG. 5. The pressure of fluid entering inlet 126 moves piston 136 to any position between the closed position, shown in FIG. 5, and the open position, shown in FIG. 6. Valve 110 may serve as a pressure relief mechanism by designing spring 152 to compress beyond either of outlets 130 or 132 when the fluid pressure at inlet 126 reaches a desired level.

Referring now to FIG. 7, an alternative embodiment of conduit according to the present invention is shown generally as 210. Conduit 210 is substantially similar to valve 10, shown in FIGS. 1-4 and 8 except that conduit 210 has only one outlet section 216 joined with inlet section 214. A portion of each of the inlet and outlet 226 and 230 is tangential to the interior surface of the housing formed by the side walls of the housing such that fluid flowing from the inlet to the outlet follows a generally helical path. Outlet 230 may be positioned at any angle with respect to inlet 226 to redirect fluid flowing through the conduit to any direction.

Referring now to FIGS. 1-4 and 8, in operation, valve 10 receives fluid through inlet 26. When piston 36 is in the open position shown in FIG. 2, the fluid exits either of outlets 30 or 32. When piston 36 is in the intermediate position shown in FIG. 3, the fluid exits outlet 30 only. When piston 36 is in the closed position shown in FIG. 4, the fluid entering inlet 26 is blocked from exiting outlets 30 and 32. Shaft 34 moves piston 36 between the open, intermediate and closed positions.

Valve 10 may be used to regulate and divert the flow of any fluid, including gas, liquid or any combination thereof. The valve may also be used to regulate the flow of a liquid-solid suspension or a combination of gas and solid material such as air and dust. Valve 10 is particularly well-suited for regulating the flow of a liquid-solid suspension because the valve does not have a narrow internal valve passageway which could become clogged by such a liquid-solid suspension. Conventional valves typically have an internal passageway that is narrower than the inlet and the outlet, and an internal valve mechanism adapted to regulate fluid flow through the passageway. When a conventional valve is used to regulate the flow of a liquid-solid suspension, there are continuous impacts between the solids within the suspension and the internal valve mechanism. These impacts damage the internal valve mechanism and cause cavitation within the liquid which damages the valve mechanism and increases pressure loss through the valve. Because valve 10 does not have a narrow passageway with an internal valve mechanism blocking the passageway, valve 10 is not damaged by regulating the flow of a liquid-solid suspension.

Valve 10 is also particularly well-suited for dividing fluid flow without pressure loss within a hydraulic or pneumatic system. For example, the valve may include an inlet with a diameter of 1″ and two outlets each having a diameter of 0.75″. Alternatively, the valve may have an inlet with a 1″ diameter and four outlets each having a 0.5″ diameter, or a 1″ inlet, a 0.75″ outlet and two 0.5″ outlets. It is within the scope of the invention for the valve to have any number of inlets and outlets each having a diameter of any size.

Referring now to FIG. 2, the fluid flowing between inlet 26 and outlets 30 and 32 follows a generally helical path through the interior of the housing. This helical path around the interior surface of the housing facilitates the flow of fluid within the valve. The continuous helical fluid flow prevents precipitation of solids within the valve, thus, preventing blocking of the valve. Therefore, there is less pressure loss in valve 10 than a conventional valve and less energy is required to move the fluid through valve 10 than is required to move fluid through a conventional valve.

Valve 110, shown in FIGS. 5 and 6, operates in substantially the same manner as valve 10, shown in FIGS. 1-4 and 8, except that piston 136 is biased to the closed position in valve 10. Therefore, piston 136 remains in the closed position until the fluid pressure at inlet 126 reaches a level sufficient to compress spring 152 and move the piston into the intermediate position allowing fluid to exit through outlet 130 or the open position allowing fluid to exit through both outlets 130 and 132. Conduit 210, shown in FIG. 7, operates in the same manner as valve 10, shown in FIGS. 1-4 and 8, except that conduit 210 only has one outlet 230 for fluid to exit through and there is no flow regulation piston positioned within conduit 210.

Thus, each of valves 10 and 110 regulate the flow of a fluid with a piston that moves in a direction perpendicular to the direction of fluid flow into and out of the valves. In conduit 210, as well as valves 10 and 110, the fluid follows a helical path through the interior of the housing to prevent pressure loss. Thus, less energy is necessary to move fluid through valves 10 and 110 and conduit 210 than in a conventional valve or flow distribution conduit. The design of valves 10 and 110 allow the valves to regulate the flow of a fluid, and in particular the flow of a liquid-solid suspension, without damage.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A conduit with helical fluid flow, comprising:
a generally cylindrical housing presenting a side wall coupled with opposing end walls;
an inlet coupled with said side wall, wherein at least a portion of said inlet is tangential to said side wall; and
an outlet coupled with said side wall.

2. The conduit of claim 1, further comprising a piston positioned within said housing and moveable between an open position allowing fluid to flow from said inlet to said outlet and a closed position blocking fluid flow from said inlet to said outlet.

3. The conduit of claim 2, wherein said piston is moveable in a direction perpendicular to the direction of fluid flow entering said inlet.

4. The conduit of claim 2, wherein said piston comprises a generally flat, circular plate having a peripheral surface adjacent said side wall.

5. The conduit of claim 4, further comprising a seal encircling said peripheral surface and engaged with said side wall.

6. The conduit of claim 2, wherein one of said end walls presents an opening for receiving a shaft, said shaft coupled with said piston for moving said piston between the open and closed positions.

7. The conduit of claim 6, further comprising a collar coupled with said shaft outside of said housing, said collar abutting said end wall when said piston is in the closed position.

8. The conduit of claim 6, wherein said piston is biased to the closed position and fluid pressure moves said piston from the closed position to the open position.

9. The conduit of claim 8, further comprising a spring biasing said piston to the closed position.

10. The conduit of claim 9, wherein said spring is a coil compression spring with a central opening received by said shaft, and wherein said spring extends between said piston and said end wall of said housing.

11. The conduit of claim 2, wherein said piston is biased to the closed position and fluid pressure moves said piston from the closed position to the open position.

12. The conduit of claim 11, further comprising a spring biasing said piston to the closed position.

13. The conduit of claim 2, wherein said outlet comprises a first outlet, wherein said conduit further comprises a second outlet coupled with said side wall, and wherein said piston is moveable to an intermediate position allowing fluid to flow from said inlet to said second outlet while blocking fluid flow from said inlet to said first outlet.

14. The conduit of claim 13, wherein said inlet is adjacent one of said end walls, said first outlet is adjacent the other of said end walls, and said second outlet is positioned between said inlet and said first outlet.

15. The conduit of claim 1, wherein said inlet is coupled with said side wall adjacent one of said end walls and said outlet is coupled with said side wall adjacent the other of said end walls.

16. The conduit of claim 1, wherein said inlet is generally cylindrical, and wherein the ratio of the diameter of the housing to the diameter of the inlet is between 1 to 5.

17. The conduit of claim 1, wherein said inlet extends from said housing in a first direction and said outlet extends from said housing in a second direction positioned at an angle to said first direction.

18. The conduit of claim 17, wherein the angle between said first direction and said second direction is between 90 to 270 degrees.

19. The conduit of claim 18, wherein said second direction is adjustable.

20. The conduit of claim 1, wherein said housing further presents:
an inlet section coupled with said inlet and presenting a pair of flanges positioned at opposite ends of said inlet section, one of said flanges coupled with one of said end walls; and
an outlet section coupled with said outlet and presenting a pair of flanges positioned at opposite ends of said outlet section, wherein one of said flanges on said outlet section is coupled with one of said flanges on said inlet section and the other of said flanges is coupled with the other of said end walls.

21. The conduit of claim 1, wherein the fluid is a liquid with solid material suspended in the liquid.

22. The conduit of claim 1, wherein the fluid entering said housing follows a generally helical path from said inlet to said outlet.

23. The conduit of claim 1, wherein at least a portion of said outlet is tangential to said side wall.

24. A valve for regulating fluid flow, comprising:
a generally cylindrical housing presenting a side wall coupled with opposing end walls;
an inlet coupled with said side wall, wherein at least a portion of said inlet is tangential to said side wall;
an outlet coupled with said side wall, wherein at least a portion of said outlet is tangential to said side wall such that fluid entering said inlet follows a generally helical path from said inlet to said outlet; and
a piston positioned within said housing and moveable between an open position allowing fluid to flow from said inlet to said outlet and a closed position blocking fluid flow from said inlet to said outlet.
